(19) United States
(12) Patent Application Publication
(10) Pub. No.: US 2012/0056465 A1
(43) Pub. Date: Mar. 8, 2012

(54) Cutting tool for a mining machine

(75) Inventors: Roman Gerer, Zeltweg (AT); Ralf Grief, Zeltweg (AT); Jan Akerman, Knittelfeld (AT)

(73) Assignee: Sandvik Mining and Construction G.m.b.H., Zeltweg (AT)

(21) Appl. No.: 13/320,231

(22) PCT Filed: May 6, 2010
(86) PCT No.: PCT/AT10/00154

§ 371 Date: Nov. 11, 2011

(30) Foreign Application Priority Data
May 14, 2009 (AT) A 751/2009

(51) Int. Cl. E21C 35/183; E21C 25/10; B23P 11/02

(52) U.S. Cl. 299/29; 29/447; 299/113

(57) ABSTRACT

In a cutting tool for a mining machine, in particular shearer, including a tool base body and a cutting insert (1) made of a diamond composite material and fixed in a receiving bore (6) of the tool base body, the diameters of the cutting insert (1) and the receiving bore (6) are dimensioned such that the cutting insert (1) is held in the receiving bore (6) by a shrink-press fit.

The invention relates to a cutting tool for a mining machine, in particular shearer, including a tool base body and a cutting insert made of a diamond composite material and fixed in a receiving bore of the tool base body. The invention further relates to a shearing drum comprising at least one cutting tool. The invention further relates to a method for producing a cutting tool.

Cutting tools for mining machines are, for instance, known in the form of so-called chisels, which are, for instance, used in coal mining or in tunnelling. Chisels are usually disposed about the periphery of a cutting or shearing drum, wherein, by selecting the appropriate incident cutting angle, it will be achieved that the usually tapering chisels, due to the rotating movement of the cutting or shearing drum, will engage with the material to be extracted, or the rock to be removed, in such a manner that material, or rock, will be detached from the surface of the mine face by cutting or scraping. Chisels, as a rule, are each comprised of a base body and a cutting insert fixed in a receiving bore of the base body. In order to also enable the efficient removal of harder rock, the cutting insert is made of a particularly hard and wear-resistant material. In this respect, tungsten carbide or a tungsten-carbide-cobalt composite has, for instance, been proposed as a material for the cutting insert.

A particularly wear-resistant configuration will be achieved by using cutting tools or chisels including tips of diamonds or polycrystalline diamond composites. The cutting insert of the cutting tool in such cases may just be provided with an outer coating of a diamond composite material or be completely comprised of such a diamond composite material.

U.S. Pat. No. 5,161,627, for instance, shows and describes a round-shaft chisel including a cutting insert that is designed to be conical with a rounded-off tip. A layer of a polycrystalline diamond composite is applied on the surface of the cutting insert. The layer is about 0.04 inch (0.1 cm). A conical cutting insert coated with a polycrystalline diamond material can also be taken from U.S. Pat. No. 4,811,801. In respect to the subject matter of U.S. Pat. No. 6,733,087, diamond, a polycrystalline diamond material, a cubic boronitride binder, free carbide or combinations thereof are cited as materials to be used for a wear-resistant coating of a cutting insert.

Based on a new generation of diamond composite materials, which are described in WO88/07409 A1 and WO90/01986 A1, a cutting tool including a tapering cutting insert made of diamond crystals that are interconnected by a silicon carbide matrix has been proposed in EP-1283936 B1. To connect the cutting insert with the tool base body, a metal matrix composite is indicated.

In addition to the material of the cutting tool, the respective cutting geometry is decisive for the cutting performance to be achieved. A cutting geometry is defined by the shape of the chisel bit, on the one hand, and by the peripheral force occurring on the chisel bit and the rock-dependent normal force, on the other hand. In order to optimize a cutting system, i.e. in order to largely reduce bending forces on the cutting chisel, the cutting geometry should be devised such that a resulting cutting force that coincides with the cutting axis, i.e. the axis of the chisel, will form. In this respect, it is to be taken care that the cutting geometry, due of the wear of the cutting insert, does not change to the effect that a resulting cutting force enclosing an angle with the chisel axis will form, which will result in a tilting load or tilting movement of the chisel and, in particular, the chisel base body.

Cutting tests have demonstrated that cutting inserts coated with diamond composite materials involve the disadvantage that the wear layer will chip off within a very short time such that the originally defined and optimized cutting geometry will no longer be provided. Better results have been achieved with cutting inserts comprised of the diamond composite materials described in the documents WO88/07409 A1 and WO90/01986 A1, since the wear is crucially reduced because of the improved wear properties and any possible wear will occur uniformly such that the cutting geometry will not be substantially changed.

These basic considerations have led to the conclusion that, in order to maintain a constantly high cutting performance, it will be of essential importance to use a cutting insert that is completely made of a diamond composite material as is, for instance, the case with the subject matter of EP-1283936 B1, while, at the same time, selecting a cutting geometry by which tilting moments on the cutting insert or the tool base body will be avoided as largely as possible. Yet, when using cutting inserts completely comprised of diamond compound materials, the problem of a sufficiently stable connection with the tool base body will arise. Due to their covalent, atomic bonds, diamonds cannot be readily wetted and joined by conventional solder materials. High soldering temperatures, moreover, bear the risk of a possible damage to the diamonds and, in addition, can lead to a decomposition of the diamonds on the interface with the solder material because of the formation of corresponding reaction layers.

The invention, therefore, aims to improve the fixation of the cutting insert within the tool base body in a simple manner and extend the service lives of cutting tools while possibly preserving their cutting geometries.

To solve this object, the invention, departing from a cutting tool of the initially mentioned type, essentially consists in that the diameters of the cutting insert and the receiving bore are dimensioned such that the cutting insert is held in the receiving bore by a shrink-press fit. The invention is based on the surprising finding that shrink-press fits in cutting inserts made of diamond composite materials will provide sufficient retaining forces and enable a durable and stable fixation of the cutting inserts even at extremely high loads on the cutting tool, for instance when cutting hard rock. In this respect, a further improvement of the fixation will result according to a preferred further development in that the cutting insert is additionally held in the receiving bore by the aid of a soldered joint, preferably by using a solder, preferably a metal solder, introduced into the receiving bore, wherein a particularly stable connection will be achieved on the interface between the cutting insert and the solder, if the cutting insert comprises an electrolytic copper coating whose thickness is preferably between 0.1 and 0.2 mm, as in correspondence with a further preferred configuration. The solder and, in particular, the electrolytic copper coating of the cutting insert are incipiently melted when soldering the cutting insert in the bore of the tool base body, wherein the cooling of the tool base body and the thus formed shrink-press fit of the cutting insert in the receiving bore will cause the incipiently melted solder or electrolytic copper coating to penetrate into the surface of the cutting insert, thus forming kind of a micro-gearing between the tool base body and the cutting insert, which will result in an extremely strong and durable connection between the cutting insert and the tool base body. In this respect, a copper-silver solder is preferably chosen as said solder.

According to a preferred further development, the diamond composite material is comprised of diamond crystals that are interconnected by a silicon carbide matrix. Such a diamond composite material has become known from WO90/01986 A1. A method for manufacturing such a diamond composite material has become known from WO88/07409 A1.

In order to achieve an optimum cutting geometry, the configuration is preferably devised such that the cutting tool is designed as a chisel and the tip of the cutting insert is substantially conically designed, with the nose angle being 60-75°, wherein it is preferably provided that the tip of the cutting insert has a tip radius of 2-5 mm, preferably 4 mm. Such a configuration of the tip of the cutting insert, particularly in combination with a further preferred configuration in which the cutting tool is oriented on the shearing drum at an incident cutting angle of 45-58°, preferably 49°, will result in optimum conditions on the point of contact between the chisel tip and the rock, wherein it is feasible to maintain the thus optimized cutting geometry over the entire service life of the cutting tool due to the extremely high wear resistance of the diamond compound material.

A further advantageous configuration will result, if the cutting tool comprises a cutting insert including a cylindrical base body having a diameter of preferably 10-18 mm, which carries the conical tip, wherein a transition radius of 35-45 mm, preferably 40 mm, is provided between the cylindrical base body and the conical tip.

A further subject matter of the invention is a shearing drum comprising at least one cutting tool, in particular a chisel, according to any one of claims 1 to 8, wherein the arrangement of the cutting tool on the shearing drum is effected in that the cutting tool is oriented on the shearing drum at an incident cutting angle of 45-58°, preferably 49°.

Overall, the configuration according to the invention ensures applicability in highly abrasive rock up to 165 MPa. Furthermore, sparking during the cutting procedure can be completely avoided. Besides, a substantial reduction of dust development will take place. The cutting forces can be reduced by about 50%. As opposed to hard-metal cutting inserts, a service life 30 times longer will be achieved. Further advantages, moreover, comprise an enhanced cutting performance as well as a reduced development of noise and heat, particularly when cutting hard rock.

A further subject matter of the invention is a method for producing a cutting tool, and, in particular, fixing a cutting insert made of a diamond composite material in a receiving bore of a tool base body. The method according to the invention is characterized by the following method steps:
a) heating of the tool base body to a temperature of at least 750° C., preferably 800-860° C.,
b) inserting of the cutting insert into the receiving bore of tool base body,
c) cooling of the tool base body in air to about 600° C.,
d) further cooling of the tool base body with water, and,
e) preferably, final tempering to about 300° C.,
   wherein the cutting insert is fixed in the receiving bore of the tool base body by a shrink-press seat due to the heating and subsequent cooling of the tool base body.

According to a preferred method control, it is further provided that electrolytic copper coating of the cutting insert is performed prior to step a), and that a solder, particularly a copper-silver solder, is introduced into the receiving bore between steps (a) and (b) such that the fixation of the cutting insert in the receiving bore is effected both by the shrink-press seat and by a soldered joint. In a preferred manner, the solder is introduced into the receiving bore in the form of a cartridge.

In the following, the invention will be described in more detail by way of exemplary embodiments schematically illustrated in the drawing. Therein,

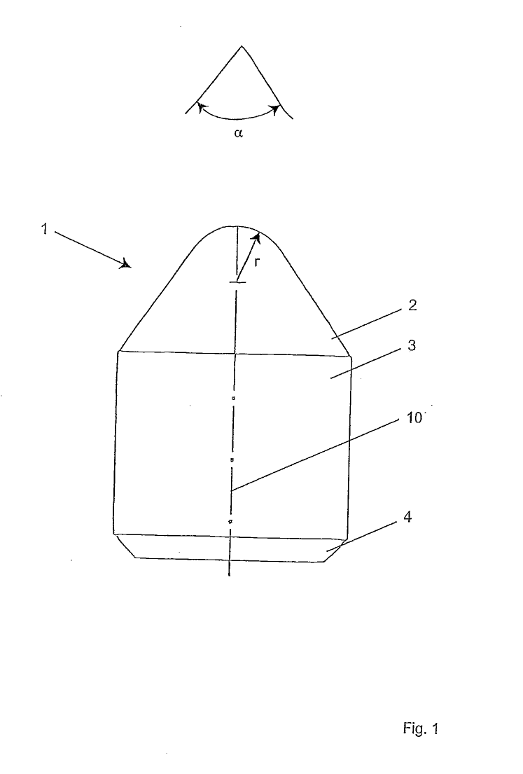

FIG. 1 illustrates, in a side view, a cutting insert made of a diamond composite material;

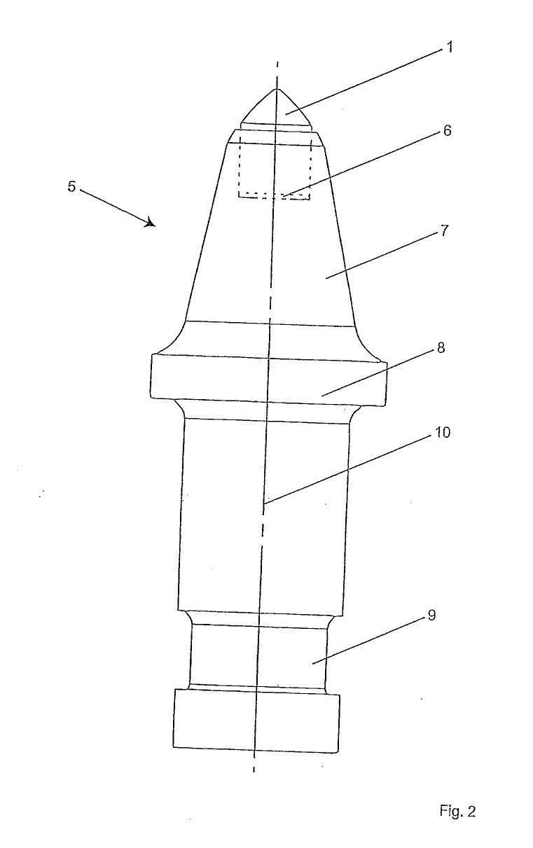

FIG. 2 depicts a cutting tool having a diamond composite cutting insert inserted therein; and

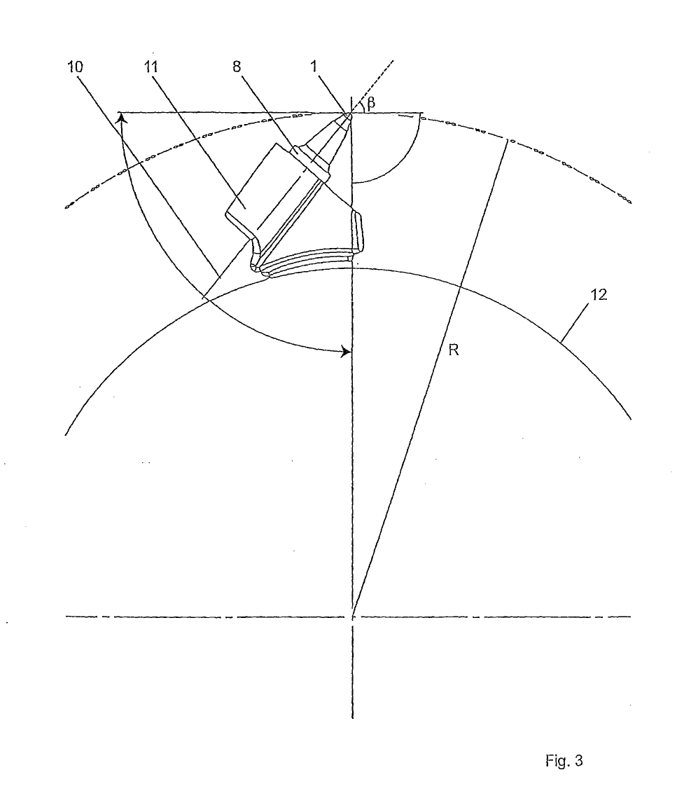

FIG. 3 illustrates the cutting geometry of a cutting tool according to the invention, which is fastened to a shearer drum.

In FIG. 1, a cutting insert made of a diamond composite material is denoted by 1, which is basically comprised of three parts: a cutting insert tip 2, a cutting insert base body 3 and a cutting insert end 4. The whole cutting insert is rotationally symmetric about a central axis 10. Accordingly, the cutting insert tip is substantially conical with its tip rounded off. The tip radius denoted by r is between 2 and 5 mm and the nose angle (α), i.e. the angle between the two diametrically opposite generatrices of the cone, in this configuration is 71°.

FIG. 2 depicts a tool base body 5 in which a cutting insert 1 is fixed in a receiving bore 6. The chisel, which is comprised of the tool base body 5 and the cutting insert 1, is rotationally symmetric about the central axis 10. On its front end, the tool base body comprises a widening portion 7 directly transitioning into an apron 8. The conical widening in the front region of the round-shaft chisel serves to stabilize the cutting tool. On the rear end of the chisel is provided a groove 9, into which a snap ring (not illustrated) can engage for fixation to a chisel holder.

FIG. 3 schematically depicts a shearer drum 12 to which a round-shaft chisel is fixed via a chisel holder 11. The apron 8 abuts on the front side of the chisel holder, thus sealing the opening of the chisel holder against the penetration of dust and rock. The radius R corresponds to the distance between the rotational axis of the shearer drum and the tip of the cutting insert engaged with the rock or mine face 13. The incident cutting angle (β) is defined as the angle between the central axis 10 of the chisel and the tangent to the circle with the radius R on the point of engagement. In the illustrated case, this angle amounts to 51°.

1. A cutting tool for a mining machine, in particular shearer, including a tool base body and a cutting insert made of a diamond composite material and fixed in a receiving bore of the tool base body, characterized in that the diameters of the cutting insert (1) and the receiving bore (6) are dimensioned such that the cutting insert (1) is held in the receiving bore (6) by a shrink-press fit.

2. A cutting tool according to claim 1, characterized in that the cutting insert (1) is additionally held in the receiving bore (6) by the aid of a soldered joint, preferably by using a solder, preferably a metal solder, introduced into the receiving bore (6).

3. A cutting device according to claim 1, characterized in that the cutting insert (1) comprises an electrolytic copper coating whose thickness is preferably between 0.1 and 0.2 mm.

4. A cutting device according to claim 1, characterized in that a copper-silver solder is chosen as said solder.

5. A cutting device according to claim 1, characterized in that the diamond composite material is comprised of diamond crystals that are interconnected by a silicon carbide matrix.

6. A cutting device according to claim 1, characterized in that the cutting tool is designed as a chisel and the tip of the cutting insert (1) is substantially conically designed, with the nose angle being 60-75°.

7. A cutting device according to claim 1, characterized in that the tip (2) of the cutting insert (1) has a tip radius of 2-5 mm.

8. A cutting device according to claim 1, characterized in that the cutting insert comprises a cylindrical base body (3) having a diameter of preferably 10-18 mm, which carries the conical tip (2), wherein a transition radius of 35-45 mm is provided between the cylindrical base body (3) and the conical tip (2).

9. A shearing drum comprising at least one cutting tool, in particular a chisel, according to claim 1, characterized in the cutting tool is oriented on the shearing drum (12) at an incident cutting angle of 45-58°.

10. A method for producing a cutting tool according to claim 1 and, in particular, fixing a cutting insert made of a diamond composite material in a receiving bore of a tool base body, comprising:
a) heating of the tool base body to a temperature of at least 750° C., preferably 800-860° C.,
b) inserting of the cutting insert into the receiving bore of tool base body,
c) fooling of the tool base body in air to about 600° C.,
d) further cooling of the tool base body with water, and,
e) preferably, final tempering to about 300° C., wherein the cutting insert is fixed in the receiving bore of the tool base body by a shrink-press seat due to the heating and subsequent cooling of the tool base body.

11. A method according to claim 10, characterized in that electrolytic copper coating of the cutting insert is performed prior to step a), and that a solder, particularly a copper-silver solder, is introduced into the receiving bore between steps (a) and (b) such that the fixation of the cutting insert in the receiving bore is effected both by the shrink-press seat and by a soldered joint.

12. A method according to claim 11, characterized in the solder is introduced into the receiving bore in the form of a cartridge.

13. A cutting device according to claim 7, wherein the tip (2) has a cutting radius of 4 mm.

14. A cutting device according to claim 8, wherein said transition radius is 40 mm.

15. A shearing drum according to claim 9, wherein said incident angle is 49°.
